(19) United States
(12) Patent Application Publication
(10) Pub. No.: US 2004/0242391 A1
(43) Pub. Date: Dec. 2, 2004

(54) Pivoting type tool pot

(76) Inventors: Kazuhiko Araki, Osaka (JP); Michio Oitaka, Osaka (JP); Atsushi Maeda, Osaka (JP)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/831,816

(22) Filed: Apr. 26, 2004

(30) Foreign Application Priority Data
May 26, 2003 (JP) 2003-147822

(51) Int. Cl. B23Q 3/157

(52) U.S. Cl. 483/65; 483/62; 483/67

(57) ABSTRACT

To provide a pivoting type tool pot having small number of parts, capable of being mounted on and removed from a tool holding rotating drum easily and capable of holding more tools on the tool holding rotating drum. In a tool pot for pivotally supporting a tool on a tool holding rotating drum in a machine tool automatic tool-replacing device, a tool pot has a tool supporting portion for removably holding the tool and a drum mount portion bolted onto the tool holding rotating drum. The drum mount portion comprises a supporting plate screwed onto a rear end portion of the tool supporting portion and a drum mount plate pivoted on the supporting plate. The tool supporting portion is pivotally supported on the tool holding rotating drum by being bolted on the tool holding rotating drum.

### FIELD OF THE INVENTION

The present invention relates to a tool pot for pivotally supporting a tool on a tool holding rotating drum in a machine tool automatic tool-replacing device.

### BACKGROUND OF THE INVENTION

To pivotally support a tool on a tool holding rotating drum in a machine tool automatic tool-replacing device, a tool pot (300) having a construction as shown in FIG. 6 has been widely used. This tool pot (300) includes a tool supporting portion (320), which removably holds a tool and a drum mount portion (340) pivoted in front of a tool holding rotating drum (400). This drum mount portion (340) is provided with a bushing (360) through which a mount pin (420) mounted onto the drum is fit-inserted. The tool pot is rotatably pivoted in front of the tool holding rotating drum by inserting the mount pin (420) fit-inserted through this bushing (360) into a semicircular arc-shaped groove provided on a convex portion (400a) of a tool pot mounting concave and convex portion formed along the outer circumference of the drum at an interval of substantially the same as the width of the tool pot, sealing the upper portion of the groove with a mount plate (440) having a groove of the same shape as that of said semicircular arc-shaped groove and securing the mount plate (440) with a bolt.

### Problems to be Solved by the Invention

In such a conventional tool pot it is necessary to provide a semicircular arc-shaped groove, which supports the mount pin (420) on the tool pot mounting concave and convex portion and said convex portion (400a), on the tool holding rotating drum (400) by cutting. This led to an increase in number of man-hours for manufacturing the tool holding rotating drum. Further, in order to mount a tool pot onto the tool holding rotating drum, the mount pin (420), the mount plates (440) and bolts (460) are needed and the number of parts were increased. Further, to remove one tool pot the removal of two mount plates (440) on both sides is needed whereby the operation was complicated. And to enhance the mounting accuracy of the tool pot to the tool holding rotating drum the cutting accuracy of the semicircular arc-shaped groove provided on the tool pot mounting concave and convex portion and said convex portion (400a) must be enhanced resulting in an increase in the manufacturing cost. Further, to dispose the mount plates on both sides of the tool pot the number of the tool pots which can be disposed on one tool holding rotating drum became small.

The object of the present invention is to provide a pivoting type tool pot having small number of parts, capable of being mounted on and removed from a tool holding rotating drum easily and capable of holding more tools on the tool holding rotating drum.

### MEANS FOR SOLVING THE PROBLEMS

To attain the object according to the present invention, a tool pot for pivotally supporting a tool on a tool holding rotating drum in a machine tool automatic tool-replacing device, is characterized in that said tool pot has a tool supporting portion for removably holding said tool and a drum mount portion bolted onto said tool holding rotating drum, said drum mount portion comprising a supporting plate screwed onto a rear end portion of said tool supporting portion and a drum mount plate pivoted on said supporting plate, and that said tool supporting portion is pivotally supported by being bolted along the outer circumference of said tool holding rotating drum in the rotating shaft direction and radial direction of said tool holding rotating drum.

In the tool pot for pivotally supporting a tool on a tool holding rotating drum in a machine tool automatic tool-replacing device, according to the present invention, a construction of the tool pot comprises a tool supporting portion for removably holding the tool and a drum mount portion bolted along the outer circumference of the tool holding rotating drum and this drum mount portion comprises a supporting plate screwed onto a rear end portion of said tool supporting portion and a drum mount plate pivoted on the supporting plate. Consequently, the tool supporting portion is pivotally supported only by being bolted in the rotation axis direction and radial direction of said tool holding rotating drum.

### BRIEF DESCRIPTION OF THE DRAWINGS

FIG. 1 is a perspective view of a machine tool automatic tool-replacing device in which a pivoting type tool pot according to the present invention can be used;

FIG. 2a is a plan view showing one example of a pivoting type tool pot according to the present invention;

FIG. 2b is a side elevation of the tool pot;

FIG. 2c is a right-hand end elevation of the tool pot as seen from the direction of the arrow C in FIG. 2a;

FIG. 3a is a plan view showing a mounted state of a plurality of the pivoting type tool pots of the form shown in FIGS. 2a-2c;

FIG. 3b is a detached view of a tool pot showing its displaced position in broken lines;

FIG. 4a is a plan view showing another example of a pivoting type tool pot according to the present invention;

FIG. 4b is a side elevation of the tool pot shown in FIG. 4a;

FIG. 4c is an end elevation of the tool pot of FIG. 4a;

FIG. 5a is a view showing a mounted state of a plurality of the pivoting type tool pots of the form shown in FIGS. 4a-4c;

FIG. 5b is a detailed view of the tool pot of FIGS. 4a-4c, showing its displaced position in broken lines;

FIG. 6a is view showing a mounted state of a conventional pivoting tool pot; and

FIGS. 6b is a detached view of the tool pot of FIG. 6a, showing its displaced position in broken lines.

### DESCRIPTION OF A PREFERRED EMBODIMENT

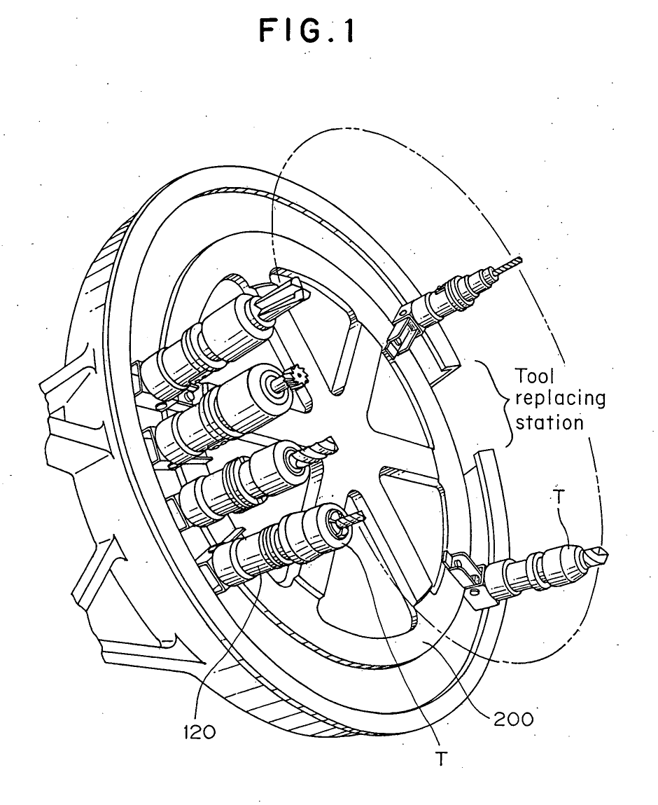

Two examples of a pivoting type tool pot according to the present invention will be described with reference to drawings. FIG. 1 is a perspective view showing one example of a machine tool automatic tool-replacing device in which a pivoting type tool pot according to the present invention is used. The machine tool automatic tool-replacing device holds tools (T), which perform various processing along the outer circumference of a tool holding rotating drum (200) while the tips of the tools (T) are directed parallel to the direction of rotating shaft. Then the tips of these tools (T) are pivoted between the rotating shaft direction and the radial direction of the tool holding rotating drum (200) by pivoting type tool pots. When the processing programs are instructed to a machine tool, a tool to be used is selected from the tool holding rotating drum, and the drum is rotated to move the associated tool to a tool replacing station. Then the tool is pivoted outward at 90 degrees to pull out of a tool pot (120) so that the tool is adhered to the machine tool. When the processing is completed the tool is returned back to the tool pot and is pivoted at 90 degrees toward the axial direction of the drum so that it is accommodated into the tool holding rotating drum.

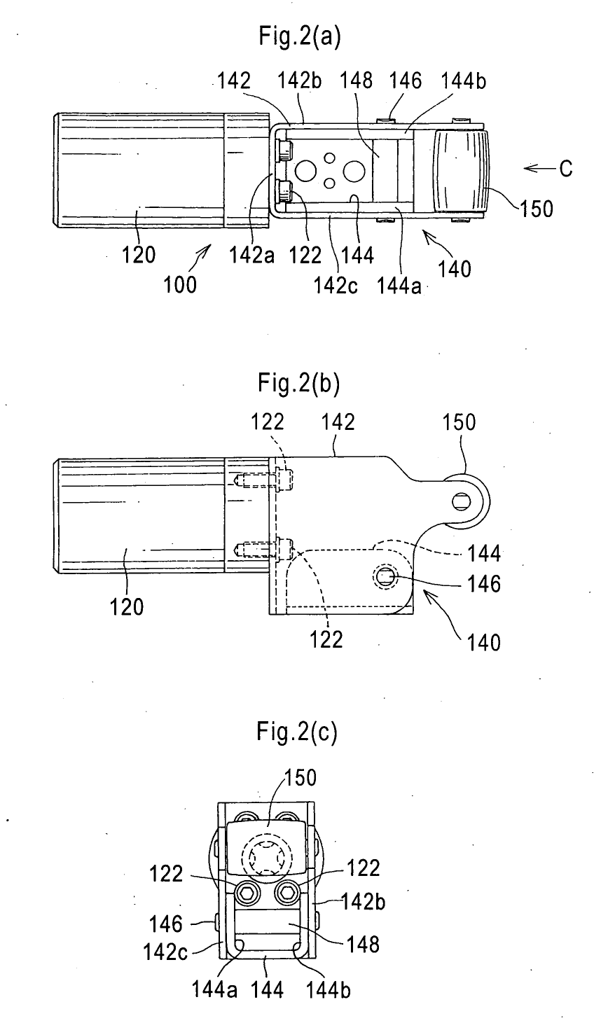

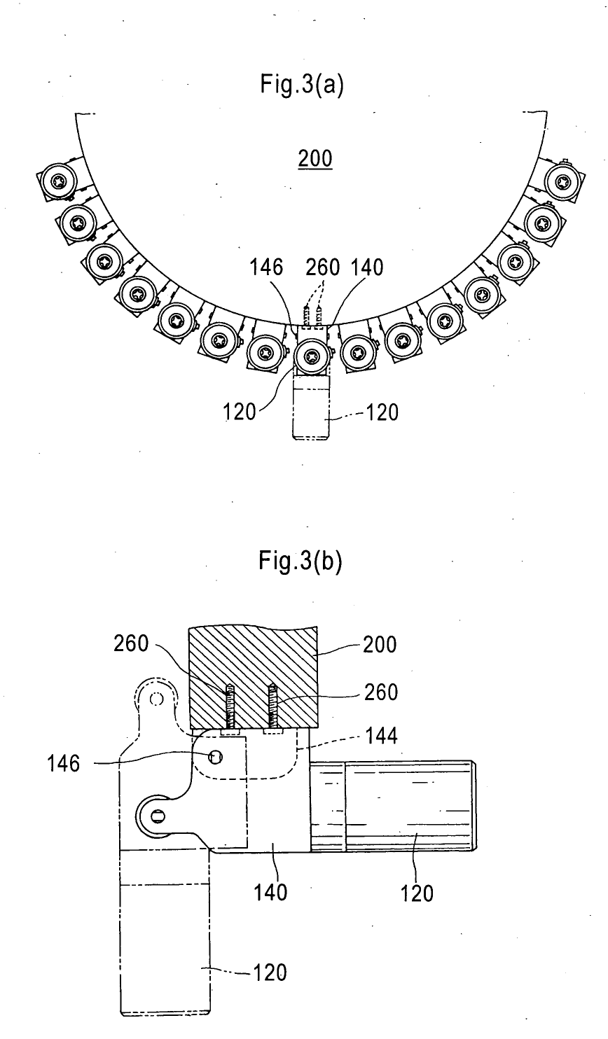

Next, one example of a pivoting type tool pot according to the present invention will be described based on FIGS. 2 and 3.

The tool pot (100) includes a tool supporting portion (120), which removably holds a tool and a drum mount portion (140) bolted onto a tool holding rotating drum (200). The drum mount portion (140) comprises a supporting plate (142) screwed onto a rear end portion of the tool supporting portion (120) and a drum mount plate (144) pivoted on the supporting plate by a pivoting fulcrum pin (146). Then as shown in FIG. 3, the tool supporting portion (120) is pivotally supported at substantial 90 degrees on the outer circumference of the tool holding rotating drum (200) by securing it with bolts (260).

As shown in FIGS. 2aand 2c, the supporting plate (142) is U-shaped in section and a rear end portion of the tool supporting portion (120) is secured to the internal surface (142a) of the supporting plate (142) with four bolts (122). The drum mount plate (144) has a U-shape in the section, which is just accommodated between opposed two surfaces (142b) (142c) of the supporting plate (142). A bushing (148) is disposed between opposed two surfaces (144a) and (144b). And the pivoting fulcrum pin (146) is loosely fitted into this bushing (148), and both ends of this pivoting fulcrum pin (146) are press-fit into the opposed two surfaces (142b) and (142c) of the supporting plate (142). As a result the supporting plate (142) is pivotally supported on the drum mount plate (144) about the pivoting fulcrum pin (146).

Further, this drum mount plate (144) is secured to the outer circumferential side of the tool holding rotating drum (200) with two bolts (260). It is noted that a member shown by a reference numeral (150) denotes a drum roller.

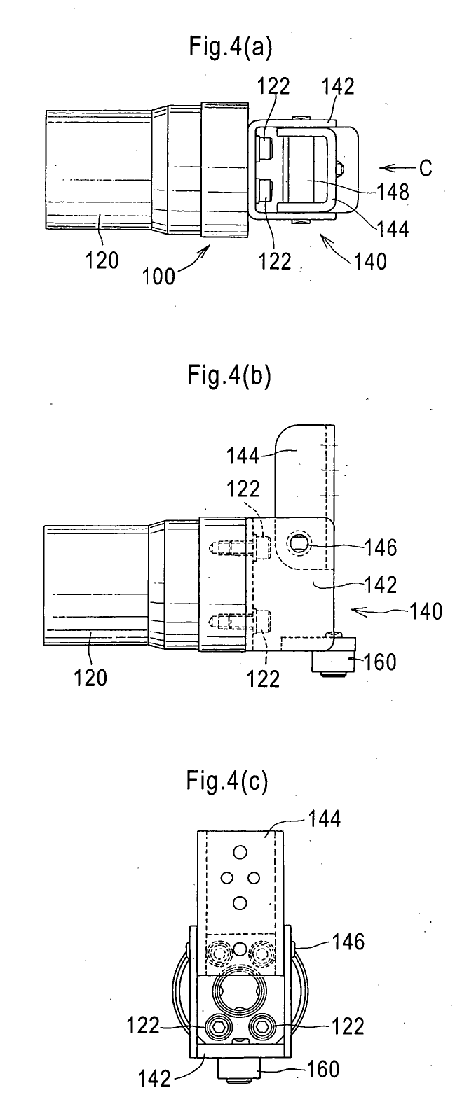

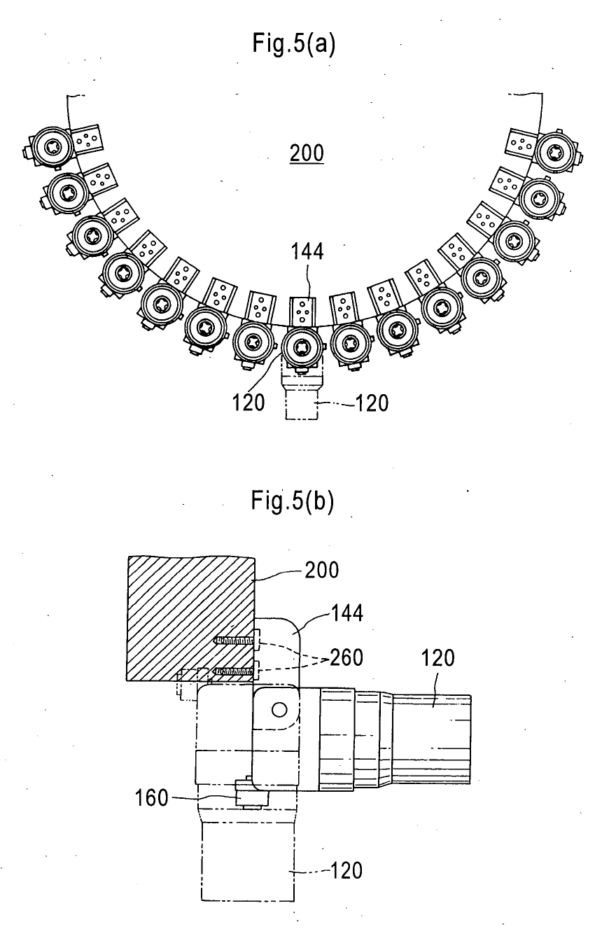

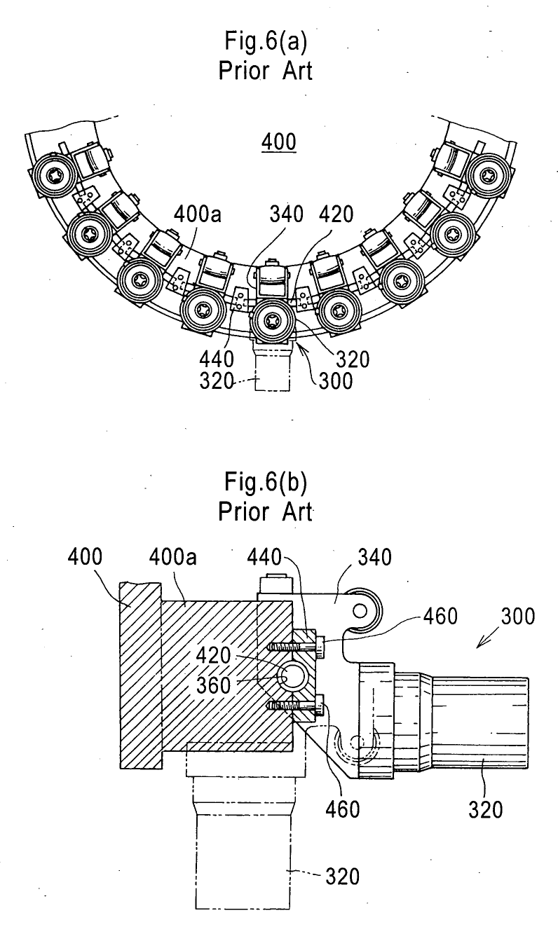

Next another example of the present invention will be described based on FIGS. 4 and 5.

In this tool pot (500) a drum mount plate (544) is pivoted between opposed two surfaces of a supporting plate (542) so that the supporting plate (542) can be pivoted outside the drum mount plate (544). And this drum mount plate (544) is fixed to an outer circumferential front of a tool supporting rotating drum (600) with two bolts (560). It is noted that a member shown by the reference numeral (560) denotes a guide roller, which is used during pivoting operation and is brought into sliding contact with a guide rail.

### Effects of the Invention

The pivoting type tool pot according to the present invention comprises a tool supporting portion for removably holding the tool and a drum mount portion bolted on the tool holding rotating drum and this drum mount portion comprises a supporting plate screwed onto a rear end portion of said tool supporting portion and a drum mount plate pivoted on the supporting plate. Consequently, the tool pot can be pivotally supported on the tool holding rotating drum only by bolting the drum mount plate pivoted on the supporting plate, onto the tool holding rotating drum. Further, the number of parts and the assembly man-hours can be reduced whereby the manufacturing cost of the device can be reduced. Further, since arranging of the mount plate on both sides of the tool pot is not needed, the number of the tool pots mounted on one tool holding rotating drum can be increased.

1. A tool pot for pivotally supporting a tool on a tool holding rotating drum in a machine tool automatic tool-replacing device, characterized in that
said tool holding drum has an outer circumference and adapted to be rotated by a shaft rotating in a given direction, and that
said tool pot has a tool supporting portion has a front portion for removably holding said tool and a drum mount portion bolted onto said tool holding rotating drum, said drum mount portion comprising a supporting plate screwed onto a rear end portion of said supporting portion and a drum mount plate pivoted on said supporting plate, and that
said tool supporting portion is pivotally supported by being bolted along the outer circumference of said tool holding rotating drum in the rotating shaft direction and projecting in a radial direction of said tool holding rotating drum.
